(19) United States
(12) Patent Application Publication
(10) Pub. No.: US 2010/0266792 A1
(43) Pub. Date: Oct. 21, 2010

(54) COMPOSITE MATERIALS AND METHOD FOR PRODUCTION THEREOF

(75) Inventors: Heike Pfistner, Ludwigshafen (DE); Andreas Fechtenkötter, Singapore (SG); Thomas Pfeiffer, Bohl-Iggelheim (DE); Wolfgang Kasel, Nussloch (DE); Michael Ehle, Ludwigshafen (DE); Bernd Düttra, Hassloch (DE); Michael Neuss, Carlsberg (DE)

Correspondence Address: CONNOLLY BOVE LODGE & HUTZ LLP, P.O. BOX 2207, WILMINGTON, DE, 19899, US

(73) Assignee: BASF SE, Ludwigshafen (DE)

(21) Appl. No.: 12/528,295

(22) PCT Filed: Feb. 20, 2008
(86) PCT No.: PCT/EP08/52028

§ 371 Date: Aug. 21, 2009

(30) Foreign Application Priority Data
Feb. 23, 2007 (EP) 07003747.8
Nov. 7, 2007 (EP) 07120172.7

(51) Int. Cl. C08L 97/02; B32B 1/00

(52) U.S. Cl. 428/35.6; 524/13

(57) ABSTRACT

Composite materials comprising at least one natural fiber, at least one thermoplastic polymer, and at least one random copolymer having a molar mass Mₙ of up to 20,000 g/mol. The random copolymer is produced from the copolymerization of ethylene and at least one comonomer. The comonomer is selected from the group consisting of ethylenically unsaturated C₃-C₁₀ monocarboxylic acids; ethylenically unsaturated C₄-C₁₀ dicarboxylic acids or their anhydrides; epoxy esters of ethylenically unsaturated C₃-C₁₀ monocarboxylic acids, and (b4) comonomers of the general formula I:

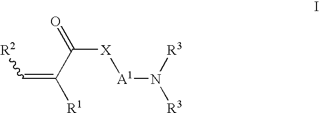

wherein R¹ and R² are a hydrogen or an unbranched or branched C₁-C₁₀-alkyl; R³ is identical or different and is a hydrogen, unbranched and branched C₁-C₁₀-alkyl or C₃-C₁₂-cycloalkyl, where two radicals R³ may be bonded together to form a 3-10-membered ring; X is an oxygen, sulfur or N—R⁴; R⁴ is an unbranched or branched C₁-C₁₀-alkyl; and A¹ is a divalent group selected from C₁-C₁₀-alkylene, C₄-C₁₀-cycyloalkylene, and phenylene.

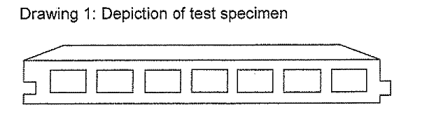

The present invention relates to composites, comprising
(A) natural fibers,
(B) at least one thermoplastic polymer,
(C) at least one random copolymer whose molar mass Mₙ is up to at most 20 000 g/mol, obtainable via copolymerization of
   (a) ethylene,
   (b) at least one reactive comonomer, selected from
      (b1) ethylenically unsaturated C₃-C₁₀ monocarboxylic acids,
      (b2) ethylenically unsaturated C₄-C₁₀ dicarboxylic acids or their anhydrides,
      (b3) epoxy esters of ethylenically unsaturated C₃-C₁₀ monocarboxylic acids,
      (b4) comonomers of the general formula I

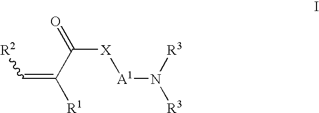

in which the definitions of the variables are as follows:
R¹ is selected from hydrogen and unbranched and branched C₁-C₁₀-alkyl,
R² is selected from hydrogen and unbranched and branched C₁-C₁₀-alkyl,
R³ is identical or different and is selected from hydrogen and unbranched and branched C₁-C₁₀-alkyl and C₃-C₁₂-cycloalkyl, where two radicals R³ can have been bonded to one another to form a 3-10-membered ring,
X is selected from oxygen, sulfur and N—R⁴,
R⁴ is selected from unbranched and branched C₁-C₁₀-alkyl,
A¹ is a divalent group selected from C₁-C₁₀-alkylene, C₄-C₁₀-cycyloalkylene, and phenylene,
and
(c) if appropriate, at least one further comonomer.

The present invention further relates to a process for the production of inventive composites. The present invention further relates to the use of inventive composites as, or for the production of, exterior parts of buildings, and to exterior parts of buildings where these parts comprise, or have been produced from, at least one inventive composite.

Wood is a material known to mankind for thousands of years. One of its features is good availability in most parts of the world. Wood is also versatile, benefiting from a large number of processing techniques. In many countries, wood continues to be used nowadays in the field of exteriors of buildings, for example in the production of roofs, of facades, of window frames, and of verandas, and also for the production of benches, such as park benches, and for the production of hollow bodies, such as hollow-chamber profiles for decking or windowsills.

One serious disadvantage of the use of wood in the field of exteriors of buildings, however, is its lack of weathering resistance. In particular, rot can be caused by hot, moist weather conditions. Although attempts to protect wood from the effects of weathering through coating, for example with layers of lacquer, can delay rotting they cannot entirely prevent it. Another disadvantage of lacquer systems is that they have to be renewed at regular intervals. Numerous lacquer systems are moreover susceptible to mechanical stresses and damage which can lead, for example, to peeling of the lacquer system. Complicated processes are moreover needed for the shaping of wood, and these are the cause of much waste.

There has been no lack of attempts to replace wood with plastics. However, the coefficients of thermal expansion of plastics such as polyvinyl chloride or polyolefins, such as polyethylene or polypropylene, prove to be excessive in many outdoor applications. Stiffness is also too low in many instances. In very recent times, composites composed of wood and plastic (wood-plastic composites, or WPC) have entered the market as a solution for numerous problems. These are produced by mixing of plastic and wood fibers. These composites have markedly higher weathering resistance than wood itself. They can also be subjected to the shaping processes used with thermoplastics, such as injection molding and extrusion.

However, one problem of composites composed of wood and plastic in many instances is lack of adequate bonding between the wood and plastic constituents. If bonding is inadequate, mechanical strength is in many instances unsatisfactory.

It was therefore an object to provide materials which have the advantages of wood-plastic composites and have improved mechanical strength. A further object was to provide a process for the production of the inventive materials. A final object was to provide uses for the inventive materials.

Accordingly, the composites defined in the introduction have been found.

Inventive composites comprise
(A) natural fibers,
(B) at least one thermoplastic polymer, also called polymer (B) for the purposes of the present invention,
(C) at least one random copolymer whose molar mass Mₙ, is up to at most 20 000 g/mol, obtainable via copolymerization of
   (a) ethylene,
   (b) at least one reactive comonomer, selected from
      (b1) ethylenically unsaturated C₃-C₁₀ monocarboxylic acids,
      (b2) ethylenically unsaturated C₄-C₁₀ dicarboxylic acids or their anhydrides,
      (b3) epoxy esters of ethylenically unsaturated C₃-C₁₀, monocarboxylic acids,
      (b4) comonomers of the general formula I

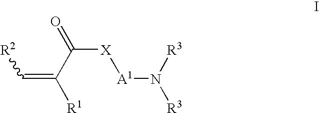

in which the definitions of the variables are as follows:
R¹ is selected from hydrogen and unbranched and branched C₁-C₁₀-alkyl,
R² is selected from hydrogen and unbranched and branched C₁-C₁₀-alkyl,
R³ is identical or different and is selected from hydrogen and unbranched and branched C₁-C₁₀-alkyl and C₃-C₁₂-cycloalkyl, where two radicals R³ can have been bonded to one another to form a 3-10-membered ring,
X is selected from oxygen, sulfur and N—R⁴,
R⁴ is selected from unbranched and branched C₁-C₁₀-alkyl,
A¹ is a divalent group selected from C₁-C₁₀-alkylene, C₄-C₁₀-cycyloalkylene, and phenylene,
and
(c) if appropriate, at least one further comonomer.

The copolymer defined above whose molar mass Mₙ is up to at most 20 000 g/mol and which is obtainable from the comonomers defined above is also abbreviated hereinafter to copolymer (C). If copolymer (C) comprises copolymerized comonomer (b4), it can be present in at least partially protonated form or in the form of free amine.

Among natural fibers (A) it is preferable to select cellulose fibers or lignocellulose-containing fibers. For the purposes of the present invention, cellulose fibers are also termed cellulose fibers (A). Examples are fibers of flax, sisal, hemp, coconut, jute, kenaf, cotton, and of abaca (Manila hemp), but also rice husks, bamboo, straw, and peanut shells. Wood fibers are preferred examples of cellulose fibers (A). These wood fibers can be fibers of unused wood or of used wood. Wood fibers can also be fibers of different types of wood, examples being softwoods from, for example, spruce, pine, fir, or larch, and hardwoods from, for example, beech and oak. Wood waste is also suitable, examples being shavings and coarse or fine waste from sawing processes. The constitution of the wood can vary in terms of its constituents, such as cellulose, hemicellulose, and lignin.

In one embodiment, cellulose fibers involve cationically or anionically modified cellulose fibers. Cationically modified cellulose fibers are reaction products of cellulose fibers with cationic reagents, e.g. glycidyltrimethylammonium chloride, substitution products of, for example, tosylcellulose with tertiary amines or with heteroaromatics, such as pyridine, or substitution products of, for example, tosylcellulose with azides, with subsequent reduction. Anionically modified cellulose fibers are cellulose derivatives such as cellulose xanthogenate, carboxymethylcellulose, cellulose phosphates, or cellulose sulfonates.

In one embodiment of the present invention, natural fibers (A) have average particle diameters in the range from 0.05 to 3.0 mm, preferably from 0.1 to 1.5 mm.

In one embodiment of the present invention, the length/thickness ratio of natural fibers (A) is in the range from 10:1 to 1:1.

Inventive composites moreover comprise at least one polymer (B). Polymer (B) is selected from any desired thermoplastically deformable polymers, which may be virgin polymers or recycled material composed of used thermoplastic polymers.

In one embodiment of the present invention, the average molar mass M_{w}, of polymer (B) is in the range from 50 000 to 1 000 000 g/mol.

In one preferred embodiment of the present invention, polymer (B) is selected from polyolefins, preferably polyethylene, in particular HDPE, polypropylene, in particular isotactic polypropylene, and polyvinyl chloride (PVC), in particular rigid PVC, and also polyvinyl acetate, and mixtures of polyethylene and polypropylene.

Each of the terms polyethylene and polypropylene here also includes copolymers of ethylene and, respectively, propylene with one or more α-olefins or styrene. For the purposes of the present invention, therefore, the term polyethylene also includes copolymers which comprise not only ethylene as main monomer (at least 50% by weight) but also one or more comonomers incorporated into the polymer, selected from styrene or α-olefins, such as propylene, 1-butene, 1-hexene, 4-methyl-1-pentene, 1-octene, 1-decene, 1-dodecene, n-α-C₂₂H₄₄, n-α-C₂₄H₄₈, and n-α-C₂₀H₄₀. For the purposes of the present invention, the term polypropylene also includes copolymers which comprise not only propylene as main monomer (at least 50% by weight) but also one or more comonomers incorporated into the polymer, selected from styrene, ethylene, 1-butene, 1-hexene, 4-methyl-1-pentene, 1-octene, 1-decene, 1-dodecene, n-α-C₂₂H₄₄, n-α-C₂₄H₄₈, and n-α-C₂₀H₄₀.

In another preferred embodiment of the present invention, thermoplastic polymer (B) is selected from biodegradeable thermoplastics. For the purposes of the present invention, compliance with the feature “biodegradeable” for a thermoplastic is achieved when the thermoplastic concerned is degraded in accordance with the requirements of DIN EN 13432 (December 2000). At least 90% degradation in a maximum of 6 months under aerobic conditions is a precondition here. Polyesters are examples of degradeable thermoplastics.

Preferred examples of biodegradeable thermoplastics are polylactide (also termed PLA), polyhydroxybutyrate (also termed PHB), which can have been produced from 3-hydroxybutyric acid or from 4-hydroxybutyric acid or from a mixture of the same, and other preferred examples are polyhydroxyvalerate (PHV), mixtures of polyhydroxy-alkanoates, such as polyhydroxybutyrate/valerate (PHBN) or a mixture of semiaromatic polyesters, e.g. Ecoflex® (BASF Aktiengesellschaft). The monomers concerned here can be present in the form of racemate or in their optically active form.

Other preferred examples are biodegradeable thermoplastics are polyesters, where these are obtainable via polycondensation of one or more diols with one or more dicarboxylic acids. Particularly suitable dials are aliphatic C₂-C₁₀ diols, such as ethylene glycol, and preferably aliphatic C₄-C₁₀ diols, such as 1,4-butanediol, 1,6-hexanediol, 1,8-octanediol, and 1,10-decanediol. Particularly suitable dicarboxylic acids are aliphatic C₂-C₁₀ dicarboxylic acids, such as oxalic acid, and preferably aliphatic C₄-C₁₀ dicarboxylic acids, such as succinic acid, glutaric acid, and adipic acid, and also mixtures of the abovementioned dicarboxylic acids. Other suitable dicarboxylic acids are aromatic dicarboxylic acids, such phthalic acid, terephthalic acid, and isophthalic acid.

In one particularly preferred embodiment of the present invention, biodegradeable thermoplastics involve polyesters modified at least one terminal group, for example via reaction with

(aa) anhydrides, in particular polymeric anhydrides, such as copolymers of ethylene with maleic anhydride,
(bb) epoxides, in particular copolymers of ethylene with ethylenically unsaturated epoxides, such as glycidyl (meth)acrylate.

It is possible here that all of the terminal groups of biodegradeable thermoplastic have been completely, or only partially, reacted via reaction with anhydride or epoxide. In the latter case, the unreacted terminal groups of biodegradeable thermoplastic are available for further chemical reactions. If an excess of epoxide or anhydride is used, the unreacted epoxide groups or unreacted anhydride groups can be utilized for crosslinking reactions.

Inventive composites moreover comprise a copolymer (C).

Copolymer (C) is random copolymers.

The molar mass Mₙ of copolymer (C) is up to at most 20 000 g/mol, preferably from 500 to 20 000 g/mol, particularly preferably from 1000 to 15 000 g/mol.

In one embodiment of the present invention, the kinematic melt viscosity v of copolymer (C) is in the range from 60 to 150 000 mm²/s, preferably from 300 to 90 000 mm²/s, measured at 120° C. to DIN 51562.

If a reactive comonomer has been selected from ethylenically unsaturated C₃-C₁₀ monocarboxylic acids (b1) and ethylenically unsaturated C₄-C₁₀ dicarboxylic acids or their anhydrides (b2), the acid number of copolymer (C) can be in the range from 1 to 200 mg KOH/g, preferably from 5 to 180 mg KOH/g, in particular from 120 to 180 mg KOH/g of copolymer (C), determined to DIN 53402.

In one embodiment of the present invention, melting points of copolymer (C) are in the range from 60 to 110° C., preferably in the range from 75° C. to 109° C., determined by DSC to DIN 51007.

In one embodiment of the present invention, the density of copolymer (C) is in the range from 0.89 to 0.99 g/cm³, preferably from 0.92 to 0.97 g/cm³, determined to DIN 53479.

Copolymer (C) is obtainable via copolymerization of:
(a) ethylene
(b) at least one reactive comonomer, selected from
   (b1) ethylenically unsaturated C₃-C₁₀ monocarboxylic acids,
   (b2) ethylenically unsaturated C₄-C₁₀ dicarboxylic acids or their anhydrides,
   (b3) epoxy esters of ethylenically unsaturated C₃-C₁₀ monocarboxylic acids,
   (b4) comonomers of the general formula I

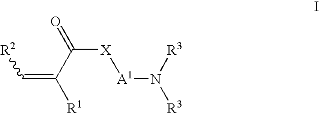

in which the definitions of the variables are as follows:
R¹ is selected from hydrogen and unbranched and branched C₁-C₁₀-alkyl,
R² is selected from hydrogen and unbranched and branched C₁-C₁₀-alkyl,
R³ is identical or different and is selected from hydrogen and unbranched and branched C₁-C₁₀-alkyl and C₃-C₁₂-cycloalkyl, where two radicals R³ can have been bonded to one another to form a 3-10-membered ring,
X is selected from oxygen, sulfur and N—R⁴,
R⁴ is selected from unbranched and branched C₁-C₁₀-alkyl,
A¹ is a divalent group selected from C₁-C₁₀-alkylene, C₄-C₁₀-cycyloalkylene, and phenylene,
and
(c) if appropriate, at least one further comonomer.

If reactive comonomers (b) are incorporated into the polymer of copolymer (C) they can enter into reactions, for example crosslinking reactions.

Particular ethylenically unsaturated C₃-C₁₀ monocarboxylic acids (b1) that may be mentioned are α,β-unsaturated C₃-C₁₀ monocarboxylic acids, such as crotonic acid and preferably (meth)acrylic acid.

Examples that may be mentioned of ethylenically unsaturated C₄-C₁₀ dicarboxylic acids (b2) are itaconic acid, metaconic acid, citraconic acid, fumaric acid, and in particular maleic acid. Examples that may be mentioned of their anhydrides are itaconic anhydride and in particular maleic anhydride.

Examples that may be mentioned of epoxy esters of ethylenically unsaturated C₃-C₁₀ monocarboxylic acids (b3) are compounds formally composed of a C₃-C₁₀ monocarboxylic acid and of an epoxidized unsaturated alcohol, for example of a compound of the formula II

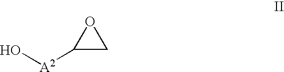

where A² is selected from C₁-C₄-alkylene groups, preferably CH₂CH₂, and particularly preferably CH₂.

Particular examples that may be mentioned of epoxy esters of ethylenically unsaturated C₃-C₁₀ monocarboxylic acids (b3) are glycidyl esters of crotonic acid and (meth)acrylic acid, where A²═CH₂, preferably glycidyl acrylate and in particular glycidyl methacrylate.

In comonomers of the general formula I (b4), also referred to by the abbreviated term comonomer (b4),

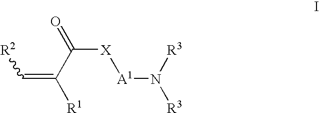

the definitions of the variables are as follows:
R¹ and R² are identical or different;
R¹ is selected from hydrogen and
unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl, and tert-butyl, in particular methyl;
R² is selected from unbranched and branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl, and tert-butyl, in particular methyl;
and very particularly preferably hydrogen.
R³ are different or preferably identical, and selected from hydrogen and branched and preferably unbranched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; preferably methyl, ethyl, n-propyl, n-butyl, n-pentyl, isopentyl, n-hexyl, n-heptyl, n-octyl, n-nonyl, n-decyl; particularly preferably C₁-C₄-alkyl, such as methyl, ethyl, n-propyl, isopropyl, n-butyl, isobutyl, sec-butyl, and tert-butyl, and very particularly preferably methyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl, and cyclododecyl; preference being given to cyclopentyl, cyclohexyl, and cycloheptyl,
where two radicals R³ can have been bonded to one another to form a 3- to 10-membered, preferably 5- to 7-membered, ring, if appropriate substituted by C₁-C₄-alkyl radicals,
and an N(R³)-2-group can particularly preferably have been selected from

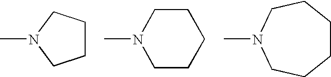

If the radicals R³ are different, one of the radicals R³ can be hydrogen.

X is selected from sulfur, N—R⁴, and in particular oxygen.

R⁴ is selected from unbranched and branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl, and tert-butyl, in particular methyl;

and A¹ is selected from divalent groups, e.g.
C₁-C₁₀-alkylene, such as —CH₂—, —CH(CH₃)—, —(CH₂)₂—, —CH₂—CH(CH₃)—, cis- and trans-CH(CH₃)—CH(CH₃)—, —(CH₂)₃—, —CH₂—CH(C₂H₅)—, —(CH₂)₄—, —(CH₂)₅—, —(CH₂)₆—, —(CH₂)₇—, —(CH₂)₈—, —(CH₂)₉—, —(CH₂)₁₀—; preferably C₂-C₄-alkylene; such as —(CH₂)₂—, —CH₂—CH(CH₃)—, —(CH₂)₃—, —(CH₂)₄—, and —CH₂—CH(C₂H₅)—, particularly preferably —(CH₂)₂—, —(CH₂)₃—, —(CH₂)₄—, and very particularly preferably —(CH₂)₂—.
C₄-C₁₀-cycyloalkylene, for example

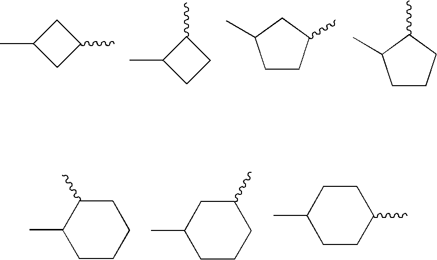

preferably

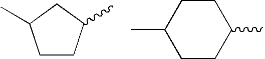

in isomerically pure form or in the form of isomer mixture,
and
phenylene, such as ortho-phenylene, meta-phenylene, and particularly preferably para-phenylene.

In one embodiment of the present invention, R¹ is hydrogen or methyl. It is particularly preferable that R¹ is methyl.

In one embodiment of the present invention, R¹ is hydrogen or methyl and R² is hydrogen.

In one embodiment of the present invention, R¹ is hydrogen or methyl and R² is hydrogen, the two groups R³ are identical, and each is methyl or ethyl.

In one embodiment of the present invention, X-A¹-N(R³)₂ is O—CH₂—CH₂—N(CH₃)₂.

In one embodiment of the present invention, X-A¹-N(R³)₂ is O—CH₂—CH₂—CH₂—N(CH₃)₂.

In one embodiment of the present invention, copolymer (C) comprises no further comonomers (c) incorporated into the polymer.

In another embodiment of the present invention, copolymer (C) comprises at least one further comonomer concomitantly incorporated into the polymer, selected from C₁-C₂₀-alkyl esters of ethylenically unsaturated C₃-C₁₀ monocarboxylic acids, also abbreviated to ethylenically unsaturated C₃-C₂₀ carboxylic esters, examples being methyl (meth)acrylate, ethyl (meth)acrylate, n-butyl (meth)acrylate, n-hexyl (meth)acrylate, 2-ethylhexyl (meth)acrylate, n-octyl (meth)acrylate, n-decyl (meth)acrylate, 2-propylheptyl (meth)acrylate,

mono- and di-C₁-C₁₀-alkyl esters of ethylenically unsaturated C₄-C₁₀ dicarboxylic acids, examples being mono- and dimethyl maleate, mono- and diethyl maleate, mono- and dimethyl fumarate, mono- and diethyl fumarate, mono- and dimethyl itaconate, mono- and di-n-butyl maleate, and mono- and di-2-ethylhexyl maleate,
vinyl esters or allyl esters of C₁-C₁₀ carboxylic acids, preferably vinyl esters or allyl esters of acetic acid or propionic acid, particularly preferably vinyl propionate and very particularly preferably vinyl acetate.

Copolymer (C) can be prepared by processes known per se for the copolymerization of ethylene (a), reactive comonomer (b), and, if appropriate, further comonomers (c), in stirred high-pressure autoclaves, or in high-pressure tubular reactors. The preparation process in stirred high-pressure autoclaves is preferred. Stirred high-pressure autoclaves are known, and an example of a description is found in Ullmann's Encyclopedia of Industrial Chemistry, 5th edition, keyword: Waxes, vol. A 28, pp. 146 et seq., Verlag Chemie Weinheim, Basle, Cambridge, New York, Tokyo, 1996. Their length/diameter ratio is mainly in the range from 5:1 to 30:1, preferably from 10:1 to 20:1. The high-pressure tubular reactors that can likewise be used are likewise found in Ullmann's Encyclopedia of Industrial Chemistry, 5th edition, keyword: Waxes, vol. A 28, pp. 146 et seq., Verlag Chemie Weinheim, Basle, Cambridge, New York, Tokyo, 1996.

Suitable pressure conditions for the copolymerization reaction are from 1000 to 3500 bar, preferably from 1500 to 2500 bar. Suitable reaction temperatures are in the range from 160 to 320° C., preferably in the range from 200 to 280° C.

Examples of regulators that can be used are aliphatic aldehydes or aliphatic ketones of the general formula III

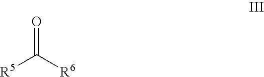

or a mixture of the same.

The radicals R⁵ and R⁶ here are identical or different, and have been selected from hydrogen;

C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl.

One radical R⁵ or R⁶ here is preferably not hydrogen.

In one particular embodiment, the radicals R⁵ and R⁶ have covalent bonding to each other to form a 4- to 13-membered ring. For example, R⁵ and R⁶ together can be:

—(CH₂)₄—, —(CH₂)₅—, —(CH₂)₆, —(CH₂)₇—, —CH(CH₃)—CH₂—CH₂—CH(CH₃)—, or —CH(CH₃)—CH₂—CH₂—CH₂—CH(CH₃)—.

Very particular preference is given to the use of propionaldehyde (R⁵═H, R⁶═C₂H₅) or ethyl methyl ketone (R⁶═CH₃, R⁶═C₂H₅) as regulator.

Further regulators having good suitability are unbranched aliphatic hydrocarbons, such as propane. Particularly good regulators are branched aliphatic hydrocarbons having tertiary hydrogen atoms, examples being isobutane, isopentane, isooctane, or isododecane (2,2,4,6,6-pentamethylheptane). Isododecane is very particularly suitable. Further additional regulators that can be used are higher olefins, such as propylene.

The amount of regulator used corresponds to the conventional amounts used for the high-pressure polymerization process.

Initiators that can be used for the free-radical polymerization reaction are the conventional free-radical initiators, e.g. organic peroxides, oxygen, or azo compounds. Mixtures of a plurality of free-radical initiators are also suitable.

Suitable peroxides, selected from commercially available substances, are
didecanoyl peroxide, 2,5-dimethyl-2,5-di(2-ethylhexanoylperoxy)hexane, tert-amyl peroxypivalate, tent-butyl peroxypivalate, tert-amyl 2-ethyl peroxyhexanoate, dibenzoyl peroxide, tert-butyl 2-ethylperoxyhexanoate, tert-butyl diethylperoxyacetate, tert-butyl diethylperoxyisobutyrate, 1,4-di(tert-butylperoxycarbonyl)cyclohexane as isomer mixture, tert-butyl perisononanoate 1,1-di(tert-butylperoxy)-3,3,5-trimethylcyclohexane, 1,1-di(tert-butylperoxy)cyclohexane, methyl isobutyl ketone peroxide, tert-butylperoxy isopropyl carbonate, 2,2-di-tert-butylperoxybutane, or tert-butyl peroxyacetate;
tert-butyl peroxybenzoate, di-tert-amyl peroxide, dicumyl peroxide, the isomeric di(tert-butylperoxyisopropyl)benzenes, 2,5-dimethyl-2,5-di(tert-butylperoxyhexane, tert-butyl cumyl peroxide, 2,5-dimethyl-2,5-di-tert-butylperoxy)hex-3-yne, di-tert-butyl peroxide, 1,3-diisopropylbenzene moriohydroperoxide, cumene hydroperoxide, or tent-butyl hydroperoxide; or
dimeric or trimeric ketone peroxides, as disclosed in EP-A 0 813 550.

Particularly suitable peroxides are di-tert-butyl peroxide, tert-butyl peroxypivalate, tert-amyl peroxypivalate, tert-butyl peroxyisononanoate, or dibenzoyl peroxide, or a mixture of the same.

An example that may be mentioned of an azo compound is azobisisobutyronitrile (“AIBN”).

The amounts used for the feed of the free-radical initiator(s) are those conventional for the high-pressure polymerization process.

Materials known as phlegmatizers are admixed with numerous commercially available organic peroxides before they are marketed, in order to improve their handling characteristics. Examples of suitable phlegmatizers are white oil or hydrocarbons, such as in particular isododecane. These phlegmatizers can have the effect of regulating molecular weight under the conditions of the high-pressure polymerization reaction.

The quantitative proportion of the comonomers (a), (b), and, if appropriate, (c) in the feed does not usually correspond precisely to the ratio of the units in the inventively used copolymer (C), because reactive comonomers (b) are generally incorporated more easily than ethylene (a) into copolymer (C).

The feed of the comonomers ethylene (a), reactive comonomer (b), and, if appropriate, further comonomers (c) is usually carried out together, or separately.

The comonomers ethylene (a), reactive comonomer (b), and, if appropriate, further cornonomers (c) can be compressed in a compressor to polymerization pressure. In another embodiment, the comonomers are first, with the aid of a pump, brought to an elevated pressure of, for example, from 150 to 400 bar, preferably from 200 to 300 bar, and in particular 260 bar, and are then brought to the actual polymerization pressure by a compressor. In another embodiment of the present invention, the feed of ethylene (a), reactive comonomer (b), and, if appropriate, further comonomers (c) takes place directly into the high-pressure autoclave, using a high-pressure pump.

The copolymerization reaction can optionally be carried out in the absence or in the presence of solvents, but for the purposes of the present invention the following are not counted as solvent: mineral oils, white oil and other solvents which are present during the polymerization reaction in the reactor and have been used for phlegmatizing the free-radical initiator(s). Examples of suitable solvents are toluene, isododecane, isomers of xylene.

Copolymer (C) comprised within inventive composite can be present in the form of free acid or preferably in partially or completely neutralized form. By way of example, copolymer (C) can have been partially or completely neutralized with hydroxide and/or carbonate and/or hydrogencarbonate of alkaline earth metal, or preferably alkali metal, examples being sodium hydroxide, potassium hydroxide, sodium carbonate, potassium carbonate, sodium hydrogencarbonate, potassium hydrogencarbonate, or preferably with one or more amines, examples being ammonia and organic amines, such as alkylamines, N-alkylethanolamines, alkanolamines, and polyamines. Examples that may be mentioned of alkylamines are: triethylamine, diethylamine, ethylamine, trimethylamine, dimethylamine, methylamine, piperidine, morpholine. Preferred amines are monoalkanolamines, N,N-dialkylalkanolamines, N-alkylalkanolamines, dialkanolamines, N-alkylalkanolamines, and trialkanolamines, each having from 2 to 18 carbon atoms in the hydroxyalkyl radical and, if appropriate, each having from 1 to 6 carbon atoms in the alkyl radical, preferably from 2 to 6 carbon atoms in the alkanol radical, and, if appropriate, 1 or 2 carbon atoms in the alkyl radical. Very particular preference is given to ethanolamine, diethanolamine, triethanolamine, methyldiethanolamine, n-butyldiethanolamine, N,N-dimethylethanolamine, and 2-amino-2-methylpropan-1-ol. Very particular preference is given to ammonia and N,N-dimethylethanolamine. Examples that may be mentioned of polyamines are: ethylenediamine, tetramethylethylenediamine (TMEDA), diethylenetriamine, and triethylenetetramine.

In one embodiment of the present invention, inventive composites comprise an amount of natural fibers (A) in the range from 30 to 90% by weight, preferably from 40 to 85% by weight,

an amount of thermoplastic polymer (B) in the range from 9 to 69% by weight, preferably from 12 to 57,
an amount of copolymer (C) in the range from 1 to 10% by weight, preferably from 3 to 5% by weight.

Data in % by weight here are always based on the entire inventive composite.

In one embodiment of the present invention, copolymer (C) comprises, incorporated into the polymer:
(a) from 60 to 98% by weight, preferably from 70 to 97% by weight, of ethylene,
(b) from 2 to 40% by weight, preferably from 3 to 30% by weight, of reactive comonomer, selected from
   (b1) ethylenically unsaturated C₃-C₁₀ monocarboxylic acids,
   (b2) ethylenically unsaturated C₄-C₁₀ dicarboxylic acids or their anhydrides,
   (b3) epoxy esters of ethylenically unsaturated C₃-C₁₀ monocarboxylic acids,
   (b4) comonomers of the general formula I

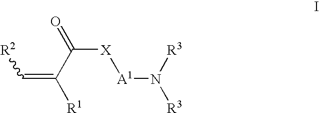

in which the definitions of the variables are as follows:
R¹ is selected from hydrogen and unbranched and branched C₁-C₁₀-alkyl,
R² is selected from hydrogen and unbranched and branched C₁-C₁₀-alkyl,
R³ is identical or different and is selected from hydrogen and unbranched and branched C₁-C₁₀-alkyl and C₃-C₁₂-cycloalkyl, where two radicals R³ can have been bonded to one another to form a 3-10-membered ring,
X is selected from oxygen, sulfur and N—R⁴,
R⁴ is selected from unbranched and branched C₁-C₁₀-alkyl,
A¹ is a divalent group selected from C₁-C₁₀-alkylene, C₄-C₁₀-cycyloalkylene, and phenylene,
and
(c) from zero to 30% by weight, preferably from 0.1 to 30% by weight, of one or more further comonomers.

Data in % by weight here are always based on the entire copolymer (C).

In one preferred embodiment of the present invention, in which reactive comonomer is selected from ethylenically unsaturated C₃-C₁₀ monocarboxylic acids (b1) and ethylenically unsaturated C₄-C₁₀ dicarboxylic acids or their anhydrides (b2), copolymer (C) comprises at most 10% by weight of further comonomer (c) incorporated into the polymer.

Inventive composites have superior weathering resistance, and moreover excellent feel, and very good mechanical properties. Thermal properties are moreover very good.

In one embodiment of the present invention, inventive composites comprise at least one additive (D). Examples of additives (D) are stabilizers, in particular light stabilizers and UV stabilizers, for example sterically hindered amines (HALS), 2,2,6,6-tetramethylmorpholine N-oxides, or 2,2,6,6-tetramethylpiperidine N-oxides (TEMPO), and other N-oxide derivatives, such as NOR. Further examples of suitable additives (D) are UV absorbers, e.g. benzophenone or benzotriazoles. Further examples of suitable additives (D) are pigments, where these can likewise provide stabilization with respect to UV light, examples being titanium dioxide, carbon black, iron oxide, other metal oxides, and organic pigments, for example azo pigments and phthalocyanine pigments. Further examples of suitable additives (D) are biocides, in particular fungicides. Further examples of suitable additives (D) are acid scavengers, such as alkaline earth metal hydroxides or alkali metal oxides, or fatty acid salts of metals, in particular metal stearates, particularly preferably zinc stearate and calcium stearate, and moreover chalk and hydrotalcites. Some fatty acid salts of metals, in particular zinc stearate and calcium stearate, can also act here as lubricants during processing.

Further examples of additives (D) are antioxidants, for example phenol-based antioxidants, e.g. alkylated phenols, bisphenols, or bicyclic phenols, or antioxidants based on benzofuranones, on organic sulfides, and/or on diphenylamines. Further examples of suitable additives (D) are plasticizers, such as phthalates, organic phosphates, esters of dicarboxylic acids, polyesters, and polyglycol derivatives. Further examples of suitable additives (D) are impact modifiers and flame retardants.

The present invention also provides a process for the production of inventive composites, also termed inventive production process for the purposes of the present invention. The inventive production process comprises mixing natural fibers (A), molten thermoplastic polymer (B), and molten or dispersed, for example emulsified, copolymer (C) with one another. The mixing process can use any of the familiar mixing apparatuses suitable for the processing of polymer melts, for example kneaders or extruders.

In one embodiment of the present invention, the procedure for the production of inventive composites starts from dried or predried natural fibers (A), in particular from dried or predried wood in fibrous form, for example from cellulose fibers whose water content is up to at most 1% by weight, based on the entire natural fibers (A) used.

In one embodiment of the present invention, the mixing is carried out in an extruder, for example in a corotating or counterrotating twin-screw extruder.

In one embodiment of the present invention, natural fibers (A), thermoplastic polymer (B), copolymer (C), and, if appropriate, one or more additives (D) are introduced into the extruder in a direct extrusion process and melted and mixed, and processed to give the ready-to-use semifinished products composed of inventive composite.

Examples of semifinished products are hollow bodies, furniture, parts of profiles, exterior parts of buildings, and interior parts of buildings.

In another embodiment of the present invention, natural fibers (A), thermoplastic polymer (B), copolymer (C), and, if appropriate, one or more additives (D) are processed first via mixing to give an inventive composite produced by way of example in the form of pellets, and then by way of example are processed to give one or more semifinished products.

The present invention further provides the use of inventive composites as, or for the production of, interior parts of buildings, or exterior parts of buildings, or parts of profiles. Examples of interior parts of buildings are balustrades, for example those for interior stairs, and panels. Examples of exterior parts of buildings are roofs, facades, window frames, verandas, balustrades for exterior stairs, decking, and cladding, for example for buildings or parts of buildings. Examples of parts of profiles are technical profiles, moldings for interior applications, e.g. moldings with complex geometries, multifunction profiles, or parts of packing, and decorative parts, furniture profiles, and floor profiles.

The present invention further provides the use of inventive composites as, or for the production of, furniture, for example of tables and chairs, and in particular garden furniture, and benches, such as park benches, for the production of parts of profiles, and for the production of hollow bodies, for example of hollow-chamber profiles for decking, or of windowsills. The present invention further provides a process for the production of furniture, hollow bodies, parts of profiles, or exterior parts of buildings, using at least one inventive composite.

The present invention further provides hollow bodies, furniture, parts of profiles, exterior parts of buildings, and interior parts of buildings, produced using at least one inventive composite.

Inventive benches and exterior parts of buildings exhibit superior weathering resistance, and moreover have excellent feel, and very good mechanical properties, for example impact resistance, good flexural modulus of elasticity, and low water absorption, leading to good weathering-related properties. Thermal properties are moreover very good. The products also have an attractive appearance similar to that of wood.

### EXAMPLES ARE USED TO ILLUSTRATE THE INVENTION

### I. Preparation of Copolymers (C)

Ethylene and comonomer selected from glycidyl methacrylate (b3.1), methacrylic acid (b1.1), or maleic anhydride (b2.1) were copolymerized according to table 1 in the type of high-pressure autoclave described in the literature (M. Buback et al., Chem. Ing. Tech. 1994, 66, 510). For this, the amount stated in table 1 of ethylene was fed at the reaction pressure of 1700 bar into the high-pressure autoclave. Separately from this, in examples (0.1) to (C.9), and also (C.11) the amount stated in table 1 of comonomer was first compressed to an intermediate pressure of 260 bar and then fed at the reaction pressure of 1700 bar. Separately from this, initiator solution composed of tert-amyl peroxypivalate in examples (C.1) to (C.10) in isododecane or tert-butyl peroxypivalate in isododecane in the case of example (C.11) (amount and concentration as in table 1) was fed at the reaction pressure of 1700 bar into the high-pressure autoclave. Separately from this, the amount stated in table 1 of regulator composed of propionaldehyde in isododecane, concentration as in table 1, was first compressed to an intermediate pressure of 260 bar and then fed into the high-pressure autoclave with the aid of a further compressor. The reaction temperature was 220° C. This gave copolymers (C.1) to (C.11) according to table 1 with the analytical data that can be seen in table 2. The molar masses Mₙ of the copolymers (C.1) to (C.11) were always below 20 000 g/mol.

TABLE 1
Preparation of inventively used copolymers (C.1) to (C.11)

| | | | PA in | | PO in | | | Yield of |
|---|---|---|---|---|---|---|---|---|
| | Ethylene | | ID | | ID | | Conversion | (C) |
| No. | [kg/h] | GMA [l/h] | [ml/h] | c(PA) | [l/h] | c(PO) | [%] | [kg/h] |
| (C.1) | 12 | 0.18 | 300 | 1 | 0.99 | 0.008 | 15 | 1.9 |
| (C.2) | 12 | 0.18 | 960 | 0.2 | 1.25 | 0.008 | 16 | 2.2 |
| (C.3) | 12 | 0.18 | 540 | 0.2 | 1.96 | 0.006 | 15 | 2.0 |
| (C.4) | 12 | 0.30 | 310 | 1 | 1.38 | 0.008 | 15 | 2.1 |
| (C.5) | 12 | 0.30 | 950 | 0.2 | 1.55 | 0.006 | 15 | 2.1 |
| (C.6) | 12 | 0.30 | 540 | 0.2 | 1.41 | 0.006 | 15 | 2.1 |
| (C.7) | 12 | 0.44 | 320 | 1 | 1.51 | 0.011 | 15 | 2.1 |
| (C.8) | 12 | 0.47 | 990 | 0.2 | 1.93 | 0.008 | 17 | 2.5 |
| (C.9) | 12 | 0.46 | 510 | 0.2 | 1.60 | 0.006 | 17 | 2.4 |
| | | Maleic | | | | | | |
| | | anhydride | PA in | | PO in | | | Yield of |
| | Ethylene | solution | ID | | ID | | Conversion | (C.10) |
| No. | [kg/h] | [l/h] | [ml/h] | c(PA) | [l/h] | c(PO) | [%] | [kg/h] |
| (C.10) | 10.6 | 1.2 | 0 | — | 2.02 | 0.06 | 17 | 2.0 |
| | | | PA in | | PO | | | Yield of |
| | Ethylene | Methacrylic | ID | | in ID | | Conversion | (C) |
| No. | [kg/h] | acid [l/h] | [ml/h] | c(PA) | [l/h] | c(PO) | [%] | [kg/h] |
| (C.11) | 12 | 0.72 | 0 | — | 1.18 | 0.0 | 18 | 2.9 |

Note:
In the case of preparation of (C.10), the amount stated in the table of maleic anhydride solution in the form of 40% by weight solution in ethyl methyl ketone was compressed to 1700 bar by a high-pressure pump and separately fed into the high-pressure autoclave .
Notes to table 1:
The reactor temperature was 220° C., GMA = glycidyl methacrylate; for preparation of (C.1) to (C.3), GMA was added in the form of solution in toluene (1:1 v/v) data for amounts of GMA feed are based on GMA without solvent), and for preparation of (C.4) to (C.9) GMA was added without dilution.
PO: tert-amyl peroxypivalate,
c(PA): concentration of PA in ID in parts by volume,
1: pure PA,
c(PO): concentration of PO in ID in mol/l.
Conversion is based on ethylene.

TABLE 2
Analytical data for inventively used copolymers (C)

| | Ethylene | | | | |
|---|---|---|---|---|---|
| | content | | | | |
| No. | [% by wt.] | | v [mm²/s] | Tₘₑₗₜ [° C.] | ρ [g/cm³] |
| | | GMA content | | | |
| | | [% by wt.] | | | |
| (C.1) | 91.8 | 8.2 | 1030 | 104.0 | 0.9422 |
| (C.2) | 91.1 | 8.9 | 4700 | 104.5 | 0.9389 |
| (C.3) | 92.1 | 7.9 | 25 100 | 105.1 | 0.9359 |
| (C.4) | 88.0 | 12.0 | 1060 | 101.1 | 0.9452 |
| (C.5) | 88.2 | 11.8 | 5030 | 102.1 | 0.9434 |
| (C.6) | 87.2 | 12.8 | 27 000 | 101.6 | 0.9421 |
| (C.7) | 83.2 | 16.8 | 950 | 96.9 | 0.9491 |
| (C.8) | 82.0 | 18.0 | 5100 | 96.9 | 0.9482 |
| (C.9) | 83.5 | 16.5 | 26 700 | 96.6 | 0.9489 |
| | | Maleic | | | |
| | | anhydride | | | |
| | | content | | | |
| | | [% by wt.] | | | |
| (C.10) | 89.9 | 10.1 | 1020 | n.d. | n.d. |
| | | Methacrylic | | | |
| | | acid content | | | |
| | | [% by wt.] | | | |
| (C.11) | 72.8 | 27.2 | n.d. | 79.3 | 0.961 |

v: Dynamic melt viscosity, measured at 120° C. to DIN 51562.

The content of ethylene and glycidyl methacrylate in the inventively used copolymers (C.1) to (C.9) was determined by IR spectroscopy. For this, a calibration IR curve was generated from data obtained by NMR spectroscopy.

Density was determined to DIN 53479. Melting range was determined by DSC (differential scanning calorimetry, differential thermal analysis) to DIN 51007.

Content of ethylene and maleic anhydride and methacrylic acid was determined in the inventively used copolymers (C.10) and (C.11) by NMR spectroscopy.

The acid number of the inventively used copolymers (C.11) was determined to DIN 53402 and was 170 mg KOH/g (C.11). MFR (melt flow rate) of copolymer (0.11) was 10.3 g/10 min, determined with a load of 325 g at a temperature of 160° C.

### Extrusion Examples and Tests:

Materials used:

The thermoplastic polymer (B.1) used comprised Sabic® HDPE M30053S HDPE (melt index=3.5 dg/min, measured at 190° C. with 2.16 kg (MFR), density=953 kg/m³, and melting point (DSC test to DIN 53765)=132° C.,

and the natural fibers (A.1) used comprised softwood fibers from conifers with particle sizes of from 0.7 to 1.2 mm and with bulk density of from 100 to 170 g/liter, and with about 0.5% residue after four hours of treatment at 850° C., commercially available as Lignocel® Grade F9 from JRS (Rettenmaier & Söhne GmbH+Co). The proportion of wood fiber in all of the mixtures was 75% by weight.

As comparison (comp. C.12), a commercially available PE-g-MA was used (Licocene® PE MA 4351 from Clariant).

The additive (D.1) added comprised a processing aid (lubricant), if appropriate calcium stearate.

Production of inventive composites and of comparative materials in the form of profiles:

Profiles composed of inventive composites or of comparative materials were produced in a counterrotating twin-screw extruder (DS 7.22D from Weber Maschinenfabrik). (A.1), (B.1), and the relevant copolymer (C) according to table 3, and also, if appropriate, the processing aid (D.1) were added to the main intake of the extruder, and processed to give the ready-to-use profile in one step, by direct extrusion. The extruder was operated at 20 revolutions per minute with a throughput of 40 kg/h. The temperature profile during the extrusion process, in the direction of mass flow, from T1 to T12, was 190° C. in zones T1 and T2, 180° C. in zones T3 to T5, 170° C. in zones T6 to T11, and 40° C. in zone T12. Of the zones T1 to T12, T1 to T5 are the temperatures in the barrel, T6 and T7 are the temperatures in the adapter flange, T8 to T11 are the temperatures in the die, and T12 is the temperature of the cooling plates at the end of the die.

The profiles produced are facade-cladding profiles with hollow-chamber-profiled geometry, tongue and groove (see figure).

‘VW’ in tables 3 and 4 indicates a composite.

TABLE 3
Constitution of inventive composites and comparative materials

| | (A.1) | (B.1) | | (D.1) |
|---|---|---|---|---|
| Example | [% by wt.] | [% by wt.] | Proportion of (C) | [% by wt.] |
| compVW.1 | 75 | 25 | 0 | 0 |
| compVW.2 | 75 | 24 | 0 | 1 |
| compVW.3 | 75 | 21 | 3% by wt. | 1 |
| | | | (compC.12) | |
| VW.4 | 75 | 21 | 3% by wt. (C.3) | 1 |
| VW.5 | 75 | 23 | 1% by wt. (C.5) | 1 |
| VW.6 | 75 | 21 | 3% by wt. (C.5) | 1 |
| VW.7 | 75 | 21 | 3% by wt. (C.6) | 1 |
| VW.8 | 75 | 21 | 3% by wt. (C.10) | 1 |
| VW.9 | 75 | 21 | 3% by wt. (C.11) | 1 |

Table 3: (compC.3) Polyethylene wax grafted with maleic anhydride, commercially available as Licocene ® PE MA 4351

### Test Specimens and Tests:

The test specimens studied were sawn from the profiles produced as above. The dimensions of the test specimens were 80 mm×10 mm×4 mm.

TABLE 4
Tests carried out with test specimens derived from constitution
of inventive composites and comparative materials

| | | Flexural | | | | |
|---|---|---|---|---|---|---|
| | Flexural | modulus of | Impact | Water | | Δ |
| Test | strength | elasticity | resistance | absorption | Δ width | thickness |
| specimen | [MPa] | [MPa] | [N/m²] | after 24 h [%] | [%] | [%] |
| compVW.1 | 17.53 ± 0.73 | 2346 ± 124 | 2.03 ± 0.27 | 16.09 | 3.36 | 4.14 |
| compVW.2 | 16.02 ± 0.33 | 2202 ± 51 | 2.48 ± 0.21 | 14.92 | 3.28 | 4.17 |
| compVW.3 | 23.64 ± 0.21 | 3488 ± 133 | 2.82 ± 0.26 | 9.14 | 1.29 | 3.19 |
| VW.4 | 28.09 ± 1.71 | 3898 ± 140 | 3.46 ± 0.32 | 6.83 | 1.07 | 3.20 |
| VW.5 | 25.01 ± 0.25 | 4135 ± 19 | 2.55 ± 0.18 | 11.58 | 3.00 | 5.35 |
| VW.6 | 25.83 ± 0.73 | 3894 ± 99 | 2.96 ± 0.35 | 8.68 | 2.23 | 3.15 |
| VW.7 | 29.88 ± 1.42 | 3686 ± 74 | 4.08 ± 0.57 | 6.18 | 1.02 | 3.60 |
| VW.8 | 29.41 ± 0.98 | 3937 ± 136 | 3.56 ± 0.38 | 5.26 | 1.02 | 1.85 |
| VW.9 | 35.05 ± 1.50 | 3375 ± 276 | 3.70 ± 0.22 | 7.06 | 1.12 | 3.95 |

Table 4: The test results are averages in each case from 5 measurements on test specimens. The flexural tests were carried out to DIN EN ISO 178, the impact test (Charpy, no notch) was carried out to DIN EN ISO 179eU, and water absorption was tested to DIN EN ISO 62; dimensional changes (Δ width and Δ thickness) were determined resulting from water absorption after 24 h of storage in water at 23° ± 2° C.

1. A composite, comprising
(A) at least one natural fibers,
(B) at least one thermoplastic polymer,
(C) at least one random copolymer having a molar mass Mₙ of up to 20,000 g/mol, the at least one random copolymer obtainable via copolymerization of
(a) ethylene,
(b) at least one reactive comonomer, selected from the group consisting of
(b1) ethylenically unsaturated C₃-C₁₀ monocarboxylic acids,
(b2) ethylenically unsaturated C₄-C₁₀ dicarboxylic acids or their anhydrides,
(b3) epoxy esters of ethylenically unsaturated C₃-C₁₀ monocarboxylic acids, and
(b4) comonomers of the general formula I 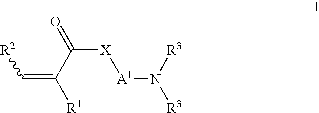
wherein:
R¹ is selected from hydrogen and unbranched and branched C₁-C₁₀-alkyl,
R² is selected from hydrogen and unbranched and branched C₁-C₁₀-alkyl,
R³ is identical or different and is selected from hydrogen and unbranched and branched C₁-C₁₀-alkyl and C₃-C₁₂-cycloalkyl, where two radicals R³ can have been bonded to one another to form a 3-10-membered ring,
X is selected from oxygen, sulfur and N—R⁴,
R⁴ is selected from unbranched and branched C₁-C₁₀-alkyl,
A¹ is a divalent group selected from C₁-C₁₀-alkylene, C₄-C₁₀-cycyloalkylene, and phenylene
(c).

2. The composite of claim 1, wherein the at least one natural fibers is any one or more selected from the group consisting of cellulose fibers and Of and lignocellulose-containing fibers.

3. The composite of claim 1, wherein the at least one natural fiber is selected from wood fibers.

4. The composite of claim 1, wherein the at least one thermoplastic polymers (B) is any one or more selected from the group consisting of polyethylene, polypropylene, and polyvinyl chloride.

5. The composite of claim 1, wherein the at least one thermoplastic polymer (B) is selected from biodegradable thermoplastics.

6. The composite of claim 14, wherein the at least one random copolymer (C) is selected from copolymers which comprise, as further comonomer (c) incorporated into the at least one random polymer, vinyl acetate or an ethylenically unsaturated C₃-C₂₀ carboxylic ester.

7. The composite of claim 1, wherein:
an amount of the at least one natural fibers (A) is in the range of 30 to 90% by weight,
an amount of the at least one thermoplastic polymer (B) is in the range of 9 to 69% by weight,
an amount of the at least one random copolymer (C) is in the range of 1 to 10% by weight.

8. The composite of claim 1, wherein the at least one random copolymer (C) comprises, incorporated into the polymer:
(a) from 60 to 98% by weight of ethylene,
(b) from 2 to 40% by weight of at least one reactive comonomer, selected from
(b1) ethylenically unsaturated C₃-C₁₀ monocarboxylic acids,
(b2) ethylenically unsaturated C₄-C₁₀ dicarboxylic acids or their anhydrides,
(b3) epoxy esters of ethylenically unsaturated C₃-C₁₀ monocarboxylic acids,
(b4) comonomers of the general formula I 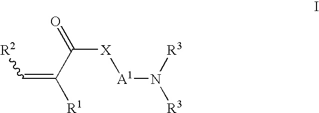
wherein:
R¹ is selected from hydrogen and unbranched and branched C₁-C₁₀-alkyl,
R² is selected from hydrogen and unbranched and branched C₁-C₁₀-alkyl,
R³ is identical or different and is selected from hydrogen and unbranched and branched C₁-C₁₀-alkyl and C₃-C₁₂-cycloalkyl, where two radicals R³ can have been bonded to one another to form a 3-10-membered ring,
X is selected from oxygen, sulfur and N—R⁴,
R⁴ is selected from unbranched and branched C₁-C₁₀-alkyl,
A¹ is a divalent group selected from C₁-C₁₀-alkylene, C₄-C₁₀-cycyloalkylene, and phenylene,
and
(c) from zero to 30% by weight of one or more further comonomers.

9. A process for the production of the composites of claim 1, which comprises mixing together the at least one natural fibers (A), the at least one thermoplastic polymer (B), and the at least one random copolymer (C), wherein the at least one thermoplastic polymer (B) is molten and the at least one random copolymer (C) is molten or dispersed.

10. The process to of claim 9, wherein the mixing is carried out in an extruder.

11. The use of composites for the production of, hollow bodies, furniture, parts of profiles, interior parts of buildings, or exterior parts of buildings.

12. A process for the production of hollow bodies, furniture, parts of profiles, interior parts of buildings, or exterior parts of buildings, using at least one composite of claim 1.

13. A hollow body, an item of furniture, a part of a profile, an interior part of a building, or an exterior part of a building, comprising, or produced using, at least one composite according to claim 1.

14. The composition, wherein the at least one random copolymer is obtainable via polymerization of the ethylene, the at least one reactive comonomer, and at least one further copolymer.
